(19) United States
(12) Patent Application Publication
(10) Pub. No.: US 2012/0327225 A1
(43) Pub. Date: Dec. 27, 2012

(54) SURVEILLANCE CAMERA WITH WIRELESS COMMUNICATION AND CONTROL CAPABILITY

(76) Inventors: Christopher B. Barley, Grand Prairie, TX (US); James Brandon Roach, Grand Prairie, TX (US)

(21) Appl. No.: 13/166,264

(22) Filed: Jun. 22, 2011

(51) Int. Cl. H04N 7/18

(52) U.S. Cl. 348/143; 348/E07.085

(57) ABSTRACT

A camera and a remote device wirelessly communicate data and commands over a first channel using respective wireless transceivers. The wireless transceiver of the camera is normally operated in a sleep mode. The remote device transmits a wake up signal on a second channel to a receiver in the camera, wherein the wireless transceiver in the camera is woken and communication is established over the first channel. The wireless unit on the camera is removably coupled thereto so that the cameras can operate with or without the unit.

### FIELD OF THE INVENTION

The present invention relates to cameras that are used to scout or surveil areas for wildlife, security, people, etc.

### BACKGROUND OF THE INVENTION

Cameras can be used to scout or surveil wildlife. For example, a camera is set up near a game trail, feeder, watering hole or other area where wildlife pass or gather on a frequent basis. The camera is mounted to a tree, post, etc. It has a sensor to detect the presence of wildlife. Thus, the camera automatically takes pictures when wildlife are detected. The automatic operation of the camera is useful because a human operator need not monitor the camera for long periods of time in order to operate it. Also, there is no human operator present which might repel wildlife.

These cameras are known as game scouting cameras or trail cameras. The cameras can be film or digital and can take still pictures or movies (video). The cameras can also be equipped with a flash. The flash can be of white light, infrared light or a camera may have both types of flashes.

The earliest cameras used to scout wildlife were believed to be conventional cameras mounted in housings to protect the camera from the weather. As scouting cameras have evolved, the cameras are specifically designed units for the particular task.

Surveillance or security cameras are used to observe an area. For example, on a construction site, cameras may be used to deter theft of equipment. Also, a surveillance camera can be used to monitor people, such as a baby or a baby sitter. Currently security cameras are relatively expensive to install because the cameras rely on electrical cables for power and to send pictures to a central location.

### SUMMARY OF THE INVENTION

A surveillance camera system comprises a camera and a remote device. The camera comprises a lens, an image sensor aligned with the lens, a processor for processing images from the image sensor, an automatic trigger and a first wireless transceiver. The trigger triggers the camera to take at least one image. The first wireless transceiver communicates over a channel. The remote device comprises a second memory for storing images and a second wireless transceiver. The second wireless transceiver communicates with the first wireless transceiver over the channel so that images from the camera first memory can be transferred over the channel to the remote device second memory.

In accordance with one aspect, the triggering sensor comprises a motion sensor.

In accordance with another aspect, the first and second wireless transceivers are first and second wifi transceivers.

In accordance with another aspect, the remote device comprises a smart phone.

There is also provided a method of operating a surveillance camera. The method detects a trigger event and takes an image with the camera in response to the trigger event. The image is stored in the camera. Using a remote device, a wireless communications channel is established with the camera. Data and commands are communicated between the remote device and the camera over the communications channel.

In accordance with one aspect, the step of detecting a trigger event further comprises detecting an object moving in proximity to the camera.

In accordance with one aspect, the step of detecting a trigger event further comprises detecting a time interval.

In accordance with one aspect, the step of communicating data and commands further comprises transferring to the remote device preliminary information relating to the images taken by the camera.

In accordance with another aspect, the step of transferring to the remote device preliminary information relating to the images further comprises transmitting thumbnail images.

In accordance with another aspect, the images which are to be transferred from the camera to the remote device are selected from the remote device. The selection of the images are transferred over the channel to the camera. The selected images are then transferred from the camera to the remote device over the channel.

In accordance with another aspect, a selected image can be edited from the remote device, wherein information relating to the edit is created and transferred to the camera over the channel.

In accordance with still another aspect, images which are to be deleted from the camera are selected from the remote device. The selected images are transferred to the camera over the channel. The selected and stored images are then deleted from the camera.

In accordance with another aspect, the step of communicating data and commands between the remote device and the camera over the channel further comprises transferring an identifier of the camera to the remote device.

In accordance with still another aspect, determining if a predetermined period of time has lapsed since the last communication of data or commands over the channel. If the predetermined period of time has lapsed, then terminating the communications channel.

There is also provided a surveillance camera that comprises a lens, an image sensor, a memory, a processor, a wireless port and a wireless unit that removably connects to the port. The wireless unit comprises a wireless transceiver.

In accordance with one aspect, the camera comprises a housing. The wireless unit removably connects to the housing.

In accordance with another aspect, the wireless unit is located on a top of the camera housing.

There is also provided a surveillance camera system that comprises a camera and remote device. The camera comprises a first memory for storing images, a first wireless transceiver, a wireless receiver and a processor. The processor operates the first transceiver in a wake mode, wherein the first transceiver can communicate over a first wireless channel, and a sleep mode, wherein the transceiver cannot communicate over the first channel. The receiver operates on a second wireless channel. A remote device has a second memory, a second wireless transceiver and a wireless transmitter. The second wireless transceiver is capable of communicating with the first wireless transceiver over the first channel. The transmitter sends a wake up signal to the camera receiver over the second channel, wherein upon reception of the wake up signal by the camera, the processor operates the first wireless transceiver in the wake mode so as to establish communication with the remote device over the first channel.

In accordance with one aspect, the camera sends images in the first memory over the first channel to the remote device.

In accordance with another aspect, the processor provides power to the first wireless transceiver to operate the first wireless transceiver in the wake mode.

In accordance with still another aspect, the processor changes the first wireless transceiver from the wake mode to the sleep mode if the first wireless transceiver does not communicate over the first channel for a predetermined period of time.

In accordance with still another aspect, the remote device comprises a first unit with the second memory and the second wireless transceiver, and a second unit with the transmitter, the first and second units are physically separable from each other.

In accordance with still another aspect, the first unit comprises a smart phone.

There is also provided a method of operating a surveillance camera. The method detects a trigger event and takes an image with the camera in response to the trigger event. The image is stored in the camera. A wireless first transceiver is provided with the camera, which first transceiver can communicate on a first channel. The wireless first transceiver is operated in a sleep mode, wherein the first transceiver does not communicate over the first channel. A remote device is provided with a wireless second transceiver. A wake up signal is sent from the remote device to the camera over a second wireless channel. After receiving the wake up signal, operating the first transceiver in a wake up mode and establishing communications between the first and second transceivers on the first channel.

In accordance with one aspect, the step of sending a wake up signal further comprises sending a coded wake up signal which is recognized in the camera.

There is also provided a method of operating a surveillance camera. The method senses an object moving and takes an image. A wireless communications channel is established between the remote device and the camera. The image is communicated over the communications channel.

### BRIEF DESCRIPTION OF THE DRAWINGS

FIG. 1 shows a surveillance camera system in wireless communication with one or more remote devices.

FIG. 2 shows the camera unit in an exploded view.

FIG. 3 shows a block diagram of the camera.

FIG. 4 shows a block diagram of the wireless unit connected to the camera.

FIG. 5 shows a block diagram of a remote device.

FIG. 6A is a flow chart of the remote device establishing communication with the camera unit.

FIG. 6B is a flow chart showing the wake up and sleep modes of the wireless unit in the camera unit.

FIGS. 7A and 7B are a flow chart illustrating the operation of the remote device to download, edit and delete data from the camera unit.

FIGS. 8-13 are example views of the display on the remote device as used for wildlife viewing. FIG. 8 shows a main menu. FIG. 9 shows the contents of the particular camera unit selected from the main menu. FIG. 10 shows an enlarged image with choices for the user. FIG. 11 shows an editing screen. FIG. 12 shows a sharing screen. FIG. 13 shows a download and delete screen.

FIG. 14 illustrates an image from a camera in another application, such as a construction site.

FIG. 15 illustrates an image from a camera in another application, such as a baby nursery.

### DESCRIPTION OF THE PREFERRED EMBODIMENTS

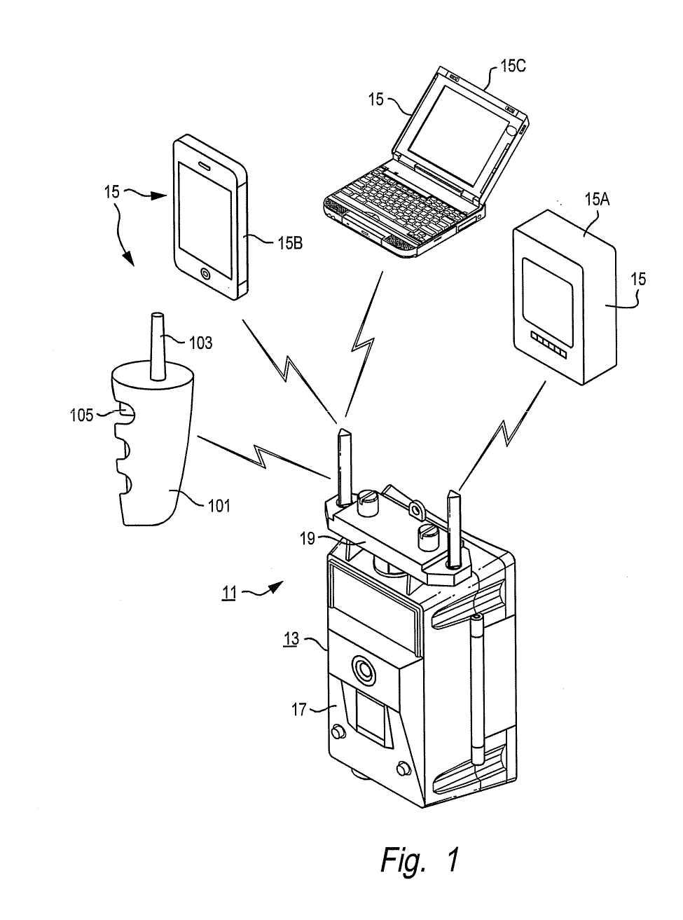

FIG. 1 shows a wireless surveillance camera system 11. In the preferred embodiment, the camera system has one or more surveillance camera units 13 designed to be located either outdoors, such as on a tree, post, etc. or indoors, such as in a warehouse. The camera unit 13 is automatically operated, taking pictures and/or video and storing the pictures or video. As used herein, “pictures” or “images” means still pictures and video, which is moving pictures with or without audio, and also means audio alone, such as contained in sound files. The image data is stored in memory for later access and use. Alternatively, the image data can be streamed to a location other than the camera, for example, a live video feed can be provided by the camera to an offsite, or remote, location.

Once the camera unit 13 is installed, it typically is left in place, and the picture or image data is removed or streamed from the camera unit for viewing. The camera is kept in place and operational so as to continue to take pictures. The picture or image data can be removed or streamed from the camera unit 13 by use of a remote device 15. (For illustration purposes, FIG. 1 shows three types of remote devices 15, which will be explained below. Also, each remote device can communicate with both antennas on the camera unit 13, as will be discussed below.) The remote device 15 wirelessly communicates with the camera unit 13. Data and commands are transferred wirelessly between the camera unit 13 and the remote device 15. The data can be the images or it can be image related (for example reduced data such as thumbnails, the identifying information from the camera, etc.). Commands can be transfer or download image data, save image data, delete image data, etc.

The remote device 15 downloads the data from the camera unit, stores it and allows processing of the data and viewing of the data. Also, the remote device 15 allows the operator to remotely program and control the camera unit 13, such as by deleting data in the camera memory (so as to free up memory for additional pictures).

The camera system 11 is useful for wildlife surveillance or scouting as such cameras are remotely located away from buildings, power supplies, etc. A camera may be located in a hard to reach location (the remote transfer of data and remote control is particularly useful). The camera system 11 is also useful for other applications, such as security. For example, construction sites suffer theft of materials and equipment and have a need for a surveillance or security camera system. As another example, the camera system 11 can be used to monitor baby nurseries.

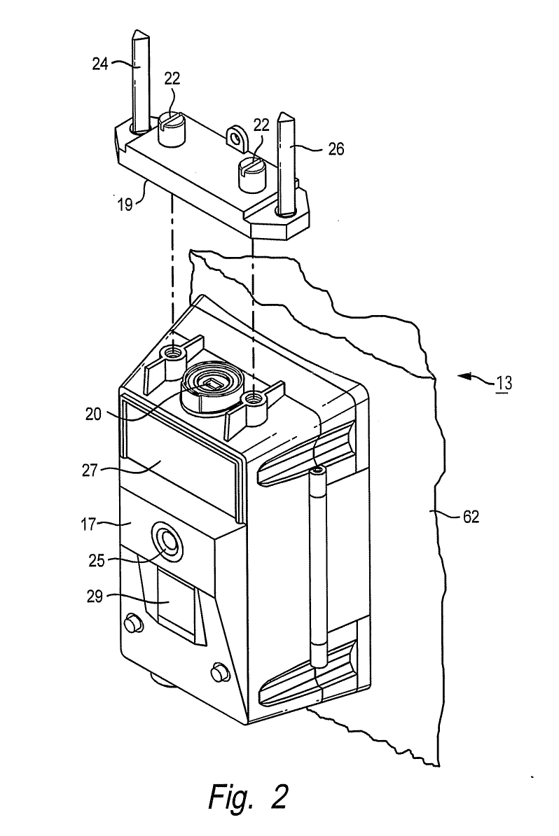

Referring to FIGS. 1 and 2, the camera unit 13 includes a camera 17 and a wireless communication unit, or wireless unit, 19. The camera and the wireless unit can be integral or they can be separate units (as shown in FIG. 2). For example, the camera 15 can operate as a stand alone camera with or without the wireless unit 19. The camera 15 stores pictures or image data in memory. An operator can access the memory in several ways. A typical example is to store the pictures in removable memory such as a memory card and remove the card from the camera to access the data thereon. To access the data on the card, the card is placed in a device such as a handheld digital camera, a computer, etc. Still another example is to plug a cable into the camera and download the data over the cable into a reader, computer, etc. As an alternative to storing the image data in memory for later retrieval, the image data can be streamed or transmitted live from the camera.

Use of a wireless unit 19 allows the data to be removed from the camera without physically contacting the camera 17, such as to remove a memory card or plug in a cable. The wireless unit 19 can be fitted to the camera to allow wireless communication. As shown in FIG. 2, the camera 17 has a connector 20 that allows the wireless unit 19 to electrically plug into the camera with a corresponding connector (not shown). Also, retainers 22, such as thumbscrews, are used to retain or couple the wireless unit to the camera. In the preferred embodiment, the wireless unit 19 is located on the top of the camera 17. The top of the camera is a good location as the antennas 24, 26 for the wireless unit are unobstructed by the camera, thereby increasing the range of communication. In addition, other sides of the camera may have one or more doors to allow access to the camera for changing batteries, viewing the display, removing a memory card, etc. The wireless unit 19 can be removed or detached from the camera 17 so that the camera can operate without wireless communication.

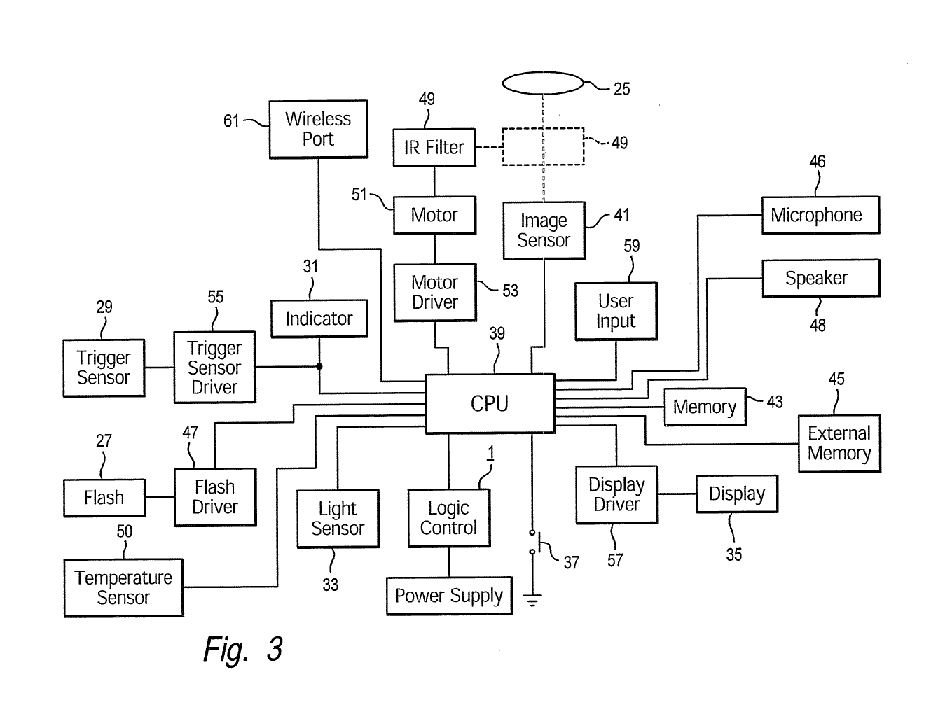

The components of the camera 17 will now be described. Referring to FIG. 2, the camera has a lens 25, a flash assembly 27 and a trigger 29. The camera also has electronics, shown in FIG. 3. A central processing unit (CPU) 39 is provided. In the preferred embodiment, the CPU incorporates features of a video processor. An image sensor 41 provides inputs to the CPU. The image sensor 41 can be a CCD or a CMOS type sensor. The image sensor is located behind the lens 25. Memory 43 is connected to the CPU 39. The memory 43 can be NAND flash memory, STRAM memory or a combination thereof, or some other type of memory. In addition, removable memory devices 45 such as memory cards, can be used. Memory cards are referred to as external memory. The memory card 45 is inserted into a slot in the camera. The camera can have solely on board (non-removable) memory, solely removable memory, or a combination of the two. The CPU 39 processes the data from the image sensor 41 and stores the image data in memory 43, 45. In the preferred embodiment, the camera stores two files relating to the image in memory. One file is for the image itself. Another file is smaller in size and is a thumbnail to allow for faster downloading. For example, if the image is 8 Mbytes, the thumbnail could be less than 100 Kbytes. As an alternative, the camera need not create or store a thumbnail file for the image. The lens 25, image sensor 41, CPU 39 and memory 43 make up the major image-taking components of the camera. The camera described herein is a digital camera. The camera can take still photographs or video. A microphone 46 is provided to pick up sound for the video. A speaker 48 is provided for messages, playback, etc.

The camera can take pictures in daylight and also in lowlight conditions, such as night, using the flash 27. In the preferred embodiment, the flash is an infrared flash, a white light flash, or a combination of the two. The flash 27 is provided by a series of LED's, which are powered by a flash driver 47. The flash driver is connected to the CPU 39. A light sensor 33, typically located on the outside of the camera, provides measurement of ambient light so as to all the CPU 39 to determine which flash (IR or white light) to use.

An infrared filter 49 is removably provided between the lens 25 and the image sensor 41. In daylight conditions, the infrared filter 49 is located in front of the image sensor 41. Thus, light passes through the infrared filter to reach the image sensor. In low light conditions, the infrared filter 49 is moved out of the light path of the image sensor so as to be out of the way. (In FIG. 2, the IR filter 49 is shown in solid lines out of the light path between the lens 25 and image sensor 41 and shown in dashed lines in the light path.) A motor 51 and a motor driver 53 move the infrared filter 49 in front of and out of the way of the image sensor. The motor driver 53 is connected to the CPU 39.

The camera, and if needed the flash 27, is automatically triggered to take an image by the trigger. In the preferred embodiment, the trigger 29, or triggering sensor, is a motion sensor. The motion sensor senses an object moving in proximity to the camera. For example, an animal may move across the field of view of the camera, from one side to the other side. Motion sensors can be active or passive. Types of active motion sensors include ultrasonic and microwave sensors. One type of passive motion sensor is a passive infrared (PIR) sensor. In the preferred embodiment, the motion sensor is a PR sensor. The PIR sensor is located behind a cover that is transparent to infrared. (FIG. 2 shows the cover in front of the sensor 29.) The PIR, or trigger, sensor 29 is connected to the CPU 39 by way of a driver 55. An indicator light is provided on the front of the camera to illuminate when the PIR sensor 29 is affected by motion. This allows the PIR sensor operation to be tested and verified.

Alternatively, another type of trigger utilizes instructions without or without sensed environmental conditions. For example, the instructions could provide that the camera take an image at specific intervals of time, such as every hour or every 6 hours. This type of camera action is useful for time lapse photography. The camera has a clock that allows the detection of intervals of time as well as the passage of time. The trigger could be coupled with sensed conditions, such as the light sensor 33. As an example, the trigger instructions could trigger the camera at dusk and dawn, as sensed by the light sensor. Alternatively as another example, the trigger instructions could trigger the camera at some interval past a light level (e.g. dusk or dawn), so that an image can be taken at an hour (or some other time) after dawn.

The camera has a display 35 for providing information. In the preferred embodiment, the display is a liquid crystal display (LCD). The LCD 35 is connected to the CPU 39 by way of an LCD driver 57. In the preferred embodiment, the display shows information such as the strength of the battery charge, the date and time, the number of pictures taken and the number of pictures remaining that can be stored with the available memory 43, 45. A power on button turns the display 35 on. The camera has a user input 59 in the form of several buttons for an operator to program the camera. The user can program various camera settings such as the clock time (including a 12 or 24 hour clock), the date, whether to take still pictures or video, number of still pictures to take after the camera is triggered, resolution of images taken, video length after triggering the camera, data and time, flash type (white light or infrared), sensitivity of the triggering sensor 29, operation times (all day, daylight or night), name of camera, etc. Many cameras provide default settings which the user can change. Other settings may include aperture, shutter speed, etc. The camera settings are commands provided by, or revised by, the user, whether through the user interface or through the remote device 15. A temperature sensor 50 is also provided. A power supply, typically batteries, along with power control electronics, are also provided.

A wireless port 61 is connected to the CPU. A buffer or driver may be provided between the CPU and the port 61. The connector 20 for the wireless port 61 is seen in FIG. 2.

The camera 17 is mounted to support structure 62 (see FIG. 2) by way of a strap, bracket, etc. The structure 62 can be a tree, post, wall, stand, etc.

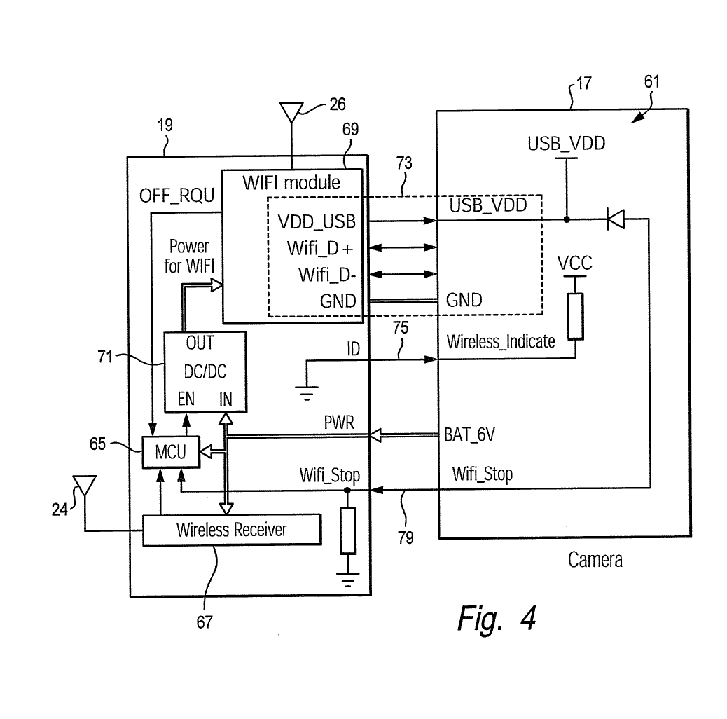

A block diagram of the wireless unit 19 is shown in FIG. 4. Also shown in FIG. 4 is a diagram of some contents of the camera 17 relating to the wireless port 61. The wireless unit 19 has a microcontroller unit 65 (MCU), or microprocessor, a type of central processing unit (CPU). The wireless unit 19 also has a wireless receiver 67 and a wireless transceiver 69. In the preferred embodiment, the wireless transceiver is a wifi module, which is conventional and commercially available. A wifi module is used in wireless or 802.11 networking. The wireless receiver 67 and the wifi module 69 are connected to their respective antennas 24, 26.

Although the wireless unit 19 could have its own power supply, such as provided by batteries, in the preferred embodiment, the wireless unit receives power from the camera 17. The MCU 65 and receiver 67 receive power from the camera whenever the camera is on. The wifi module 69 receives power upon command of the MCU 65. The wifi module 69, when operating, requires more power than does the MCU and the receiver 67. As the camera is typically battery powered, allowing the wifi module to operate continuously leads to draining the camera batteries of power. To prevent this, the wifi module 69 is operated intermittently.

For most of the time, the wireless unit 19 is in a “sleep” mode, wherein the wifi module 69 is off and does not operate. In a “wake” mode, the wireless unit 19 is capable of operating normally and communicating over a channel. The MCU 65 and the wireless receiver 67, which draw relatively little power, stay on, even in the sleep mode. The receiver 67 operates on a wake up, or secondary, channel that is separate from the wifi module's channel (primary channel). In the preferred embodiment, the wireless receiver 67 operates at 433 MHz while the wifi module 69 operates at 2.6 GHz.

Although the primary and secondary (wake up) channels have been described as wifi and rf, other wireless communication channels can be used which involve other media, signal paths, signals, frequencies, etc. For example, the channels can be rf, wifi, cellular, satellite, short range wireless technology (one example of which is Bluetooth®), and the signal can be electromagnetic (radio, light, etc.) sonic, etc. The channels can be digital or analog and can use a number of modulation schemes.

Power from the camera 17 is routed to the wifi module 69 through a dc/dc converter 71, or a power transfer device. The dc/dc converter 71 has an enabling input which is connected to an output of the MCU 65.

The MCU 65 receives inputs from the receiver 67, the wifi module 69 and from the camera 17. The wifi module 69 communicates with the camera 17 through a number of conductors, such as by a USB (universal serial bus) channel 73. The wireless unit 19 also has a connection 75 with the camera, which connection is to ground. This latter connection provides an indication to the camera 17 that the wireless unit 19 is connected to the camera.

The camera 17 provides a wifi stop signal 79 to the wifi module 69 by way of the MCU 65 and the dc/dc converter 71. For example, when the remote device 15 signals disconnect, the camera receives this by way of the wifi module 69, processes it and produces a wifi stop signal 79 to turn off the wifi module 69.

Turning now to the remote device 15, FIG. 1 shows three remote devices to illustrate several types. Typically, only one remote device is used to communicate with the camera 17 at a time. In general, the remote device is a computer with wireless communication capability. One type of remote device is a dedicated device 15A, specifically designed for operating with the camera units. Another type of remote device is a multi-purpose smart phone or small mobile computer (such as a tablet computer) 15B which can be used for operations other than with the camera unit. Still another remote device is a personal computer 15C (such as a laptop or desktop computer).

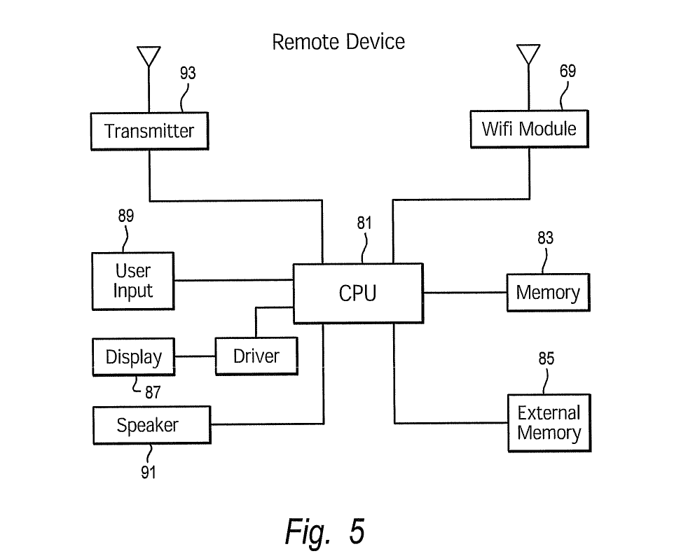

The remote device 15A is shown in FIG. 5. The remote device has a CPU 81 with memory 83 and may have external, or removable, memory 85, such as a memory card. The remote device can have internal memory 83 only, removable memory 85 only, or a combination of the two. A user interface is provided, with a display 87 and a user input 89 such as keys or buttons. The keys can be discrete and dedicated keys, or the keys can be provided on the display, which would be a touch screen. A speaker 91 can be provided. One or more drivers can be provided for the user interface. The CPU 81 is connected to a wireless transmitter 93 and to a wifi module 69. The wifi module 69 in the remote device is the same as the wifi module 69 in the wireless unit 19.

A smart phone or tablet computer 15B (see FIG. 1) contains all of the components of FIG. 5, except for perhaps an external memory and the transmitter 93. The smart phone has cellular telephone capability and therefore has a wireless transceiver. However, the transceiver operates at cellular telephone frequencies, which may be incompatible with the receiver 67 in the camera unit (FIG. 4). A tablet computer is similar to the smart phone, but may not have cellular telephone capability. To provide compatibility with the receiver 67, the smart phone or similar device is paired with a remote trigger 101 (see FIG. 1). The remote trigger 101 has a transmitter compatible with the receiver 67 in the camera unit. The remote trigger transmitter is the same as the transmitter 93 in FIG. 5. The remote trigger 101 also has an antenna 103 and a switch 105, as well as a power source such as batteries. The user holds the remote trigger 101, squeezes the switch 105 which activates the transmitter 93 to send a wake up signal on the wake up channel. As described below, once the wireless unit on the camera is woken, then the smart phone and the wireless unit will establish wireless communication without the further need of the remote trigger 101. Thus, the remote trigger can be used with any remote device, whether it be a smart phone 15B, a dedicated remote device 15A, etc.

The personal computer 15C contains all of the components of FIG. 5, except the transmitter 93. The personal computer 15C is used in conjunction with the remote trigger 101.

The remote devices 15A, 15B, 15C may of course contain other components and capabilities. For example, smart phone and personal computers are typically general purpose devices used for a variety of things such as email, document processing, listening to music, etc.

The remote trigger 101 has an indicator light that shows a user when a signal is being transmitted. The wireless unit 19 has an indicator light that shows when the wake up signal is received and another indicator light that shows when the first channel is established.

As discussed above, the remote devices 15 can have several configurations, with the transmitters and receivers for the two channels in one remote device or in two or more remote devices. Likewise, the camera unit can have several configurations of the transmitters and receivers for the channels. One configuration is as shown, where the wireless unit 19 has the transmitter and receivers for both channels. In another configuration, there is a first wireless unit having the first transceiver for communicating on the first channel, and a second wireless unit having a receiver for communicating on the second channel. The first and second wireless units are physically separate from each other. In another configuration, with first and second wireless units, one of the first or second wireless units is external to and detachable from the camera, while the other of the first or second wireless units is internal to the camera housing. In still another configuration, both wireless units are internal to the camera housing.

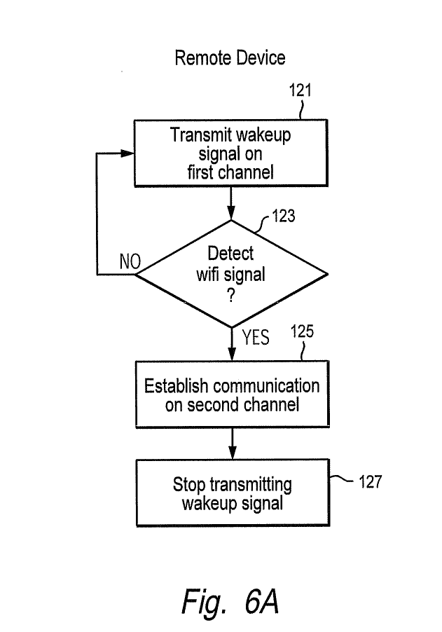

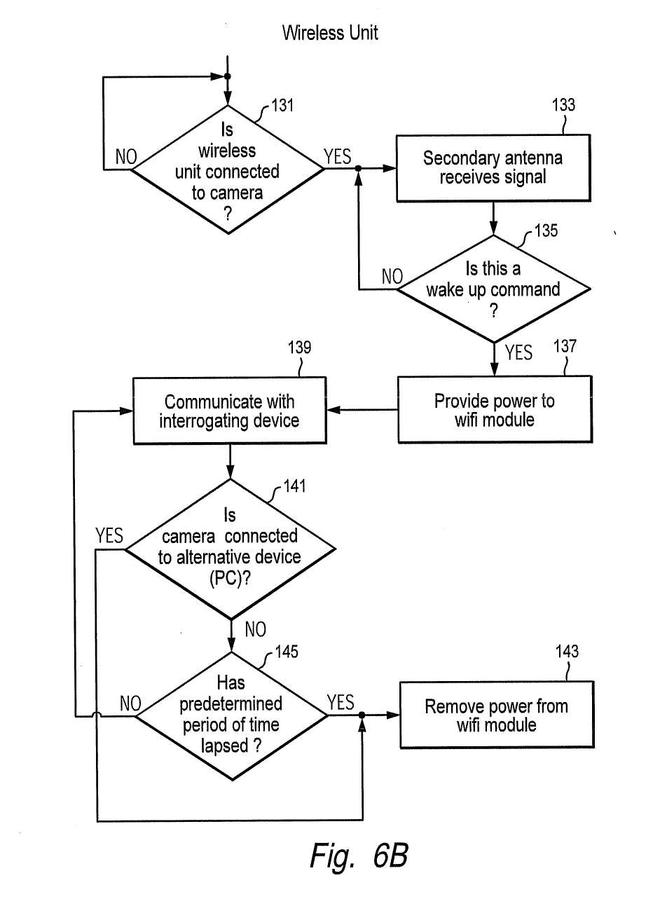

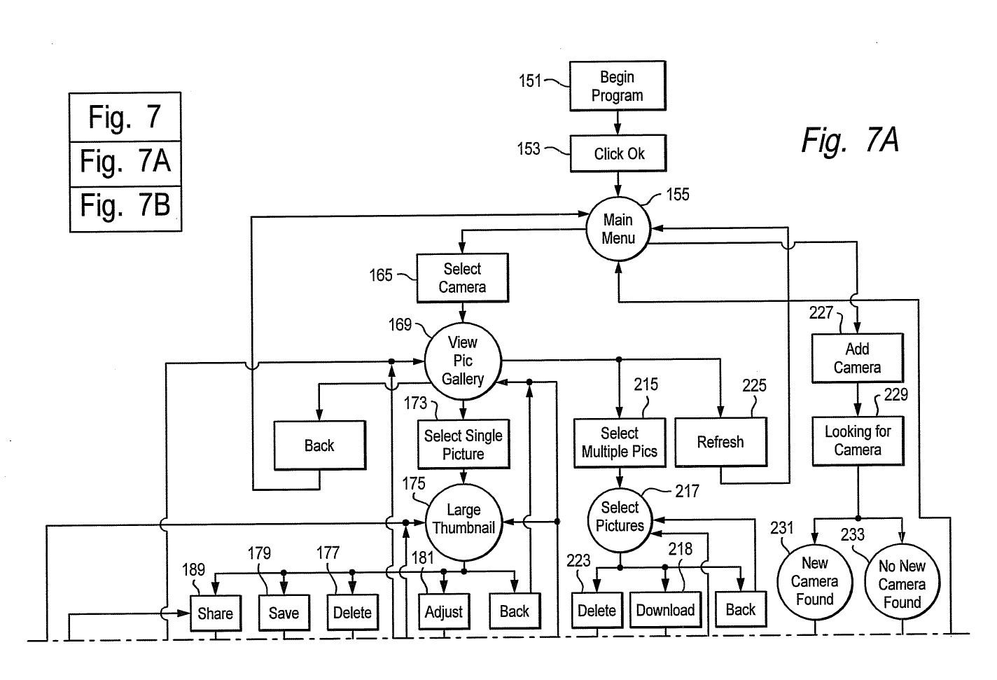

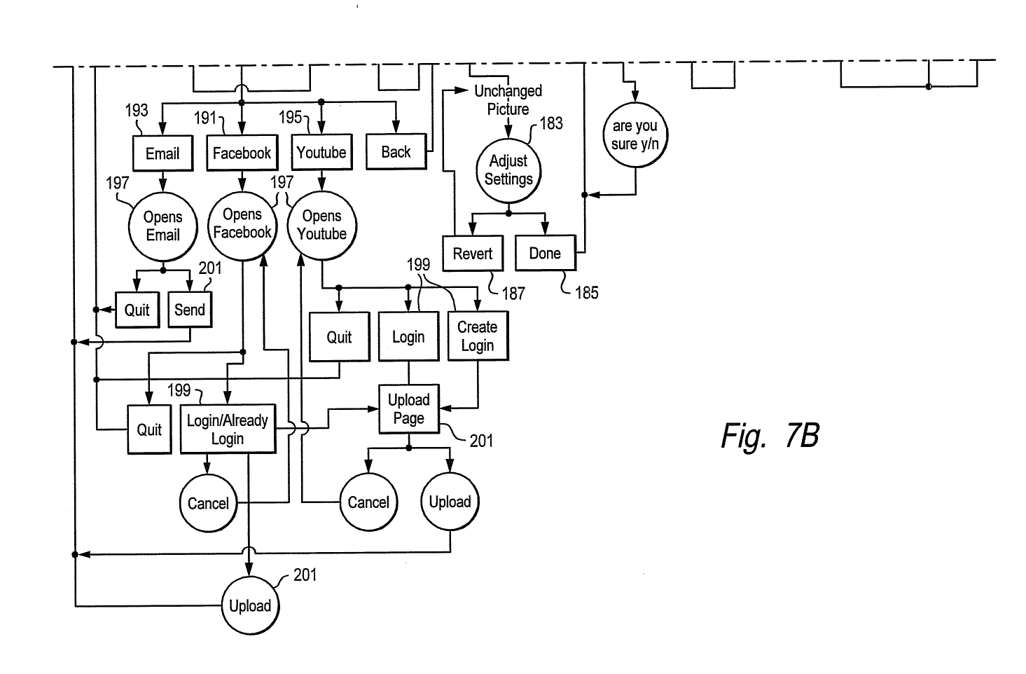

The operation of the camera system 11 will now be described. The camera system allows a number of activities to occur wirelessly between the camera unit 13 and the remote device 15. For communication to be established, with data or commands to be transferred, the wifi module 69 of the wireless unit 19 on the camera must be put in a “wake” mode from a “sleep” mode. This will be discussed with reference to FIGS. 6A and 6B. The method of FIG. 6A is carried out by the remote device 15, while the method of FIG. 6B is carried out by the wireless unit 19. Once communication is established, the remote device 15 can control and download data from the camera unit 17. This is discussed in FIGS. 7A and 7B.

The remote device 15 initiates communication by transmitting a wake up signal on the wake up, or secondary, channel, step 121 of FIG. 6A. The transmitter signal can be initiated by the user, such as by pressing a transmitter wake up button on the remote device 15A or by squeezing the trigger 105 of the remote trigger 101. The wake up signal has a predetermined configuration, such as a pulse sequence, that allows the wireless unit 19 to distinguish the signal from spurious signals or other noise. The remote device then looks for a wifi signal on the primary channel, step 123. If the wireless unit is out of range, or has not received the wake up signal, then no wifi signal is detected and the method repeats, step 121. The wake up signal need not be continuous, but can be intermittent. If a wifi signal is detected, then communication protocols are followed so as to establish communication on the primary channel, step 125. With the wifi module 69 in communication, transmission of the wake up signal is stopped, step 127. If communication is not established on the primary channel, the wake up signal ceases transmission after a period of time.

For the remote trigger 101 of FIG. 1, squeezing the trigger 105 initiates the transmitter to send a wake up signal on the first channel, step 121. The transmitter can be operated for as long as the trigger is squeezed, or for a period of time after the trigger has been squeezed (for example 3-5 seconds). The smart phone or computer 15B performs steps 123 and 125 to establish communication with the camera.

In the wireless unit 19 (see FIG. 6B), it is determined if the wireless unit is connected to a camera, step 131. This is performed by checking the USB port connection 73 (see FIG. 4). If NO, then the step repeats until a proper connection is obtained. If YES, the unit waits to receive the signal from the wake up channel, step 133. Note that the receiver 67 and MCU 65 are on, while the wifi module 69 is off. When the signal is received, it is processed to determine if the signal is a wake up command, step 135. If NO, then step 133 is repeated. If YES, then the MCU provides power to the wifi module 69 by way of the converter 71, step 137. This changes the wifi module 69 from the sleep mode to the wake mode. The wifi module 69 then establishes communication over the primary channel with the remote device, step 139. The wireless unit 19 and remote device 15 establish communication using standard protocols, such as hand shaking. Alternatively, instead of being woken by the MCU 65, the wifi module 69 can be woken by the camera 17; the signal from the receiver 67 would be processed by the camera CPU 39 which would then apply power to the wifi module.

With communication established between the remote device 15 and the wireless unit 19, commands can be provided and data transferred (see FIGS. 7A and 7B discussed below). Such data includes the name of the camera, camera settings, image data, number of images taken, available memory in number of images, and so on. Such commands include changing the camera settings, transferring or downloading data, etc.

At some point, the wifi module 69 in the wireless unit 19 is turned off to conserve power. In one instance, if the camera detects another device, such as a PC (personal computer) 63, becomes connected such as through another USB port, then YES results from step 141 of FIG. 6B and the wifi module is turned off by removing power, step 143. The MCU disables power via the converter 71 (see FIG. 4) As an alternative, if a predetermined period of time has lapsed since data was transferred, step 145, then the wifi module is turned off, step 143. The predetermined period of time can be determined by the wifi module 69, which generates an off request signal (see FIG. 4). Alternatively, the MCU can monitor usage of the wifi module.

Once communication is established between the remote device and the wireless unit, the camera sends preliminary information to the remote device, namely the name of the camera and the number of new camera images or media since the last connection with that camera.

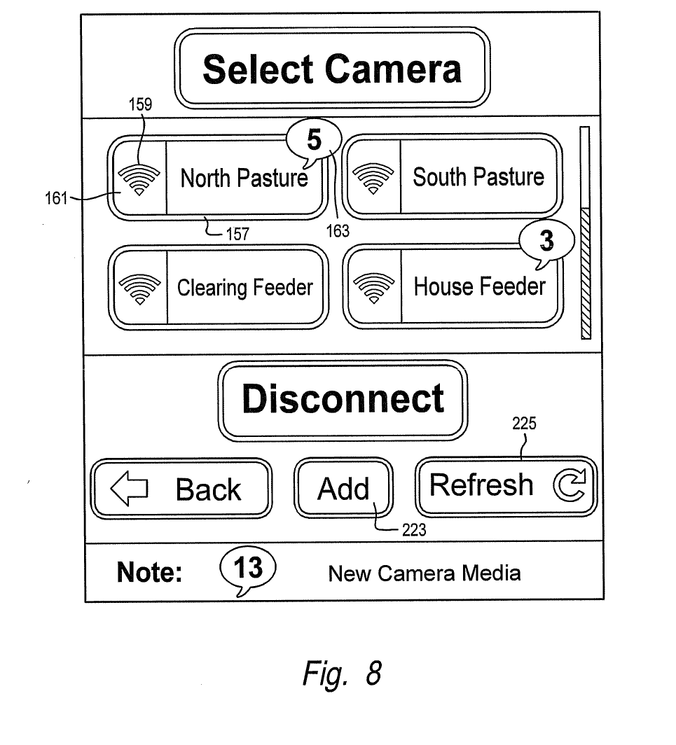

FIGS. 7A and 7B show a flow chart illustrating the remote device process. FIGS. 7A and 7B show one embodiment. Other embodiments can have more or less capability. For example, some smart phone platforms (such as Apple's iPhone) have limitations not found in other platforms. Before the communication is established, the program is begun, step 151. The first screen the user sees is to establish communication with the camera. The user presses or clicks “OK”, a button on the user interface of the remote display, step 153. This initiates step 121 of FIG. 6A to establish communications with the camera. The main menu is displayed, step 155, an example of which is shown in FIG. 8.

The main menu lists the library of cameras. When a camera is set up, the user gives the camera a name or identifying information (for example, the cameras containing the library have names such as “north pasture” 157, “house feeder”). When communication with the remote device is established, more than one camera at a time may have established communication with the remote device 15. The cameras out of communication, but contained in the library, have their names “ghosted” or made less clear to indicate to the user that they are nonactive choices on the menu. The menu may have some other indications of which cameras are in communication with the remote device. For example, a signal strength icon 159 (wherein a greater number of bars or curves shows the stronger signal) and color 161 around the bars or curves (green indicates a good connection, yellow a weak but still functional connection, red no connection) can be used.

As to those cameras in communication with the remote device, the number of new media or images is indicated by a number in a bubble 163. For example, on the north pasture camera, there are five new images, while on the house feeder camera, there are three new images. The total number of new images is displayed at the bottom. A scroll bar is provided (shown on the right side) to allow the user to see other cameras in the library.

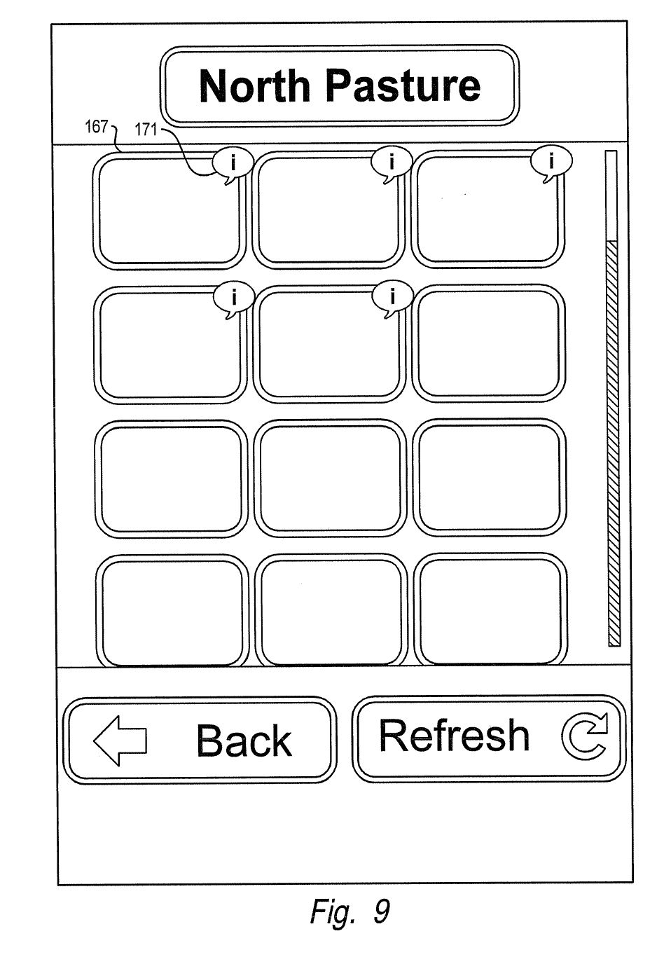

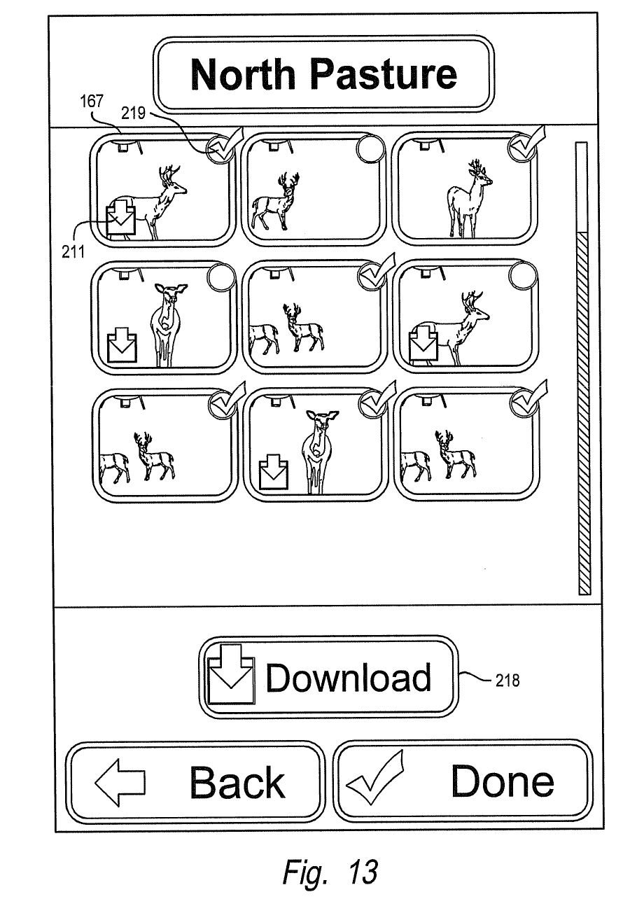

The user selects a camera in communication with the remote device, step 165 of FIG. 7A. For example, the user presses the north pasture camera button. The remote device transmits a signal to that camera, which then downloads the thumbnail files of the images from that camera, which thumbnails 167 are displayed, step 169. The thumbnails are displayed in the order of most recent taken to oldest (see FIG. 9 where the outlines of thumbnails are shown. The thumbnails contain some content, as shown in FIG. 13). Thumbnails that have not yet been viewed are so indicated by a bubble 171, or other indicator. The use of thumbnails allows the user to quickly scan through the pictures and select those of interest. With automatic cameras, some of the pictures taken may be of little or no interest to the user. For example, the user may only be interested in pictures of deer or hogs and uninterested in pictures of birds or other animals.

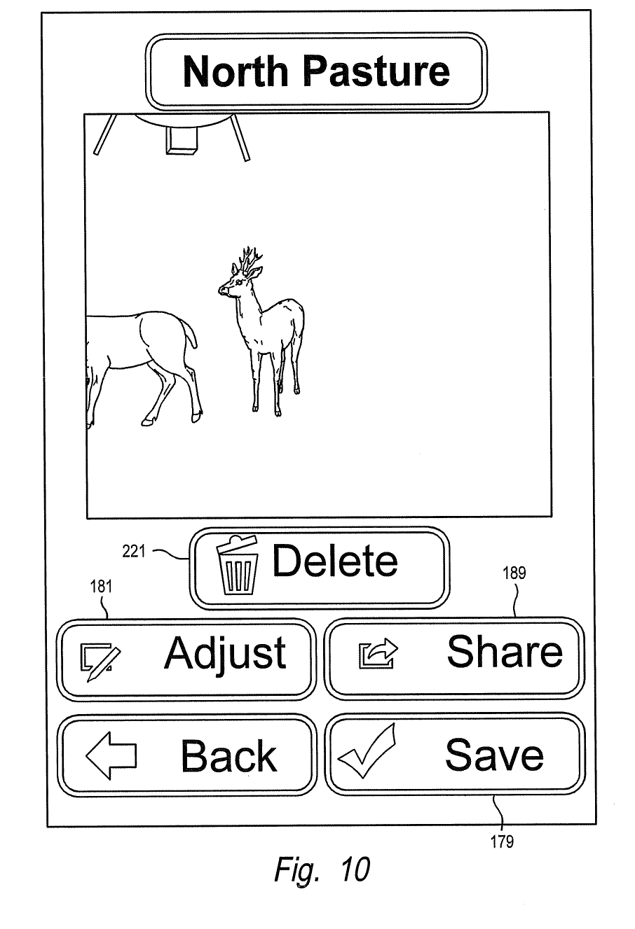

The user selects the picture by pressing on its thumbnail (for example twice), step 173. The remote device sends a request to the camera which transmits the full image file for the picture to allow viewing of a larger image with a higher resolution (see FIG. 10). Alternatively, the thumbnail is expanded using the data already sent. The larger thumbnail is displayed, step 175. As another alternative, if there is no thumbnail file, then the image is downloaded in its entirety. The user has several options of how to handle the picture. The user can delete or save the image. If “delete” is selected, step 177, the image is deleted from the remote device and the user is returned to the picture gallery, step 169, of FIG. 7A. Also, a signal is transmitted to the camera to delete the picture from the memory of the camera. If “save” is selected, step 179, the image is so marked and the user is returned to the picture gallery, step 169 of FIG. 7A. Alternatively, the image can be downloaded at this time from the camera to the remote device.

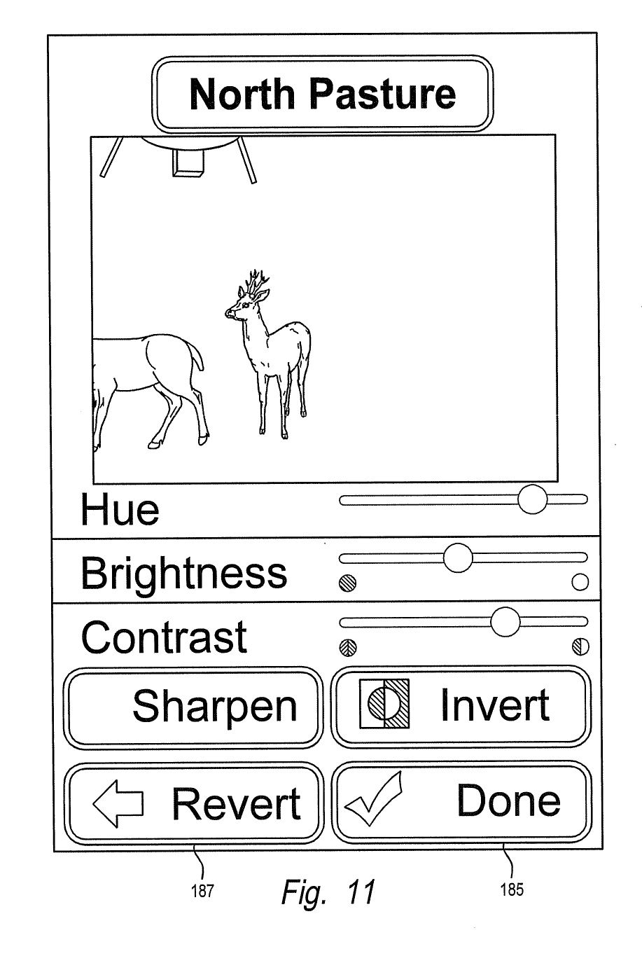

The user can edit or adjust the picture of FIG. 10 by selecting “adjust”, step 181. This displays FIG. 11, which shows a large version of the image and allows the user to make edits such as hue (from red to violet), brightness, contrast, sharpness, or invert, step 183 (see FIG. 7B). When finished with the adjustments, the user presses “done” to save the edits, step 185, wherein the edit parameters for the image are stored in memory and the user returns to the picture gallery, step 169 of FIG. 9. The edit parameters are transmitted to the camera which stores the parameters for that image. The user can delete the edits by pressing “revert”, step 187, wherein the original picture is displayed.

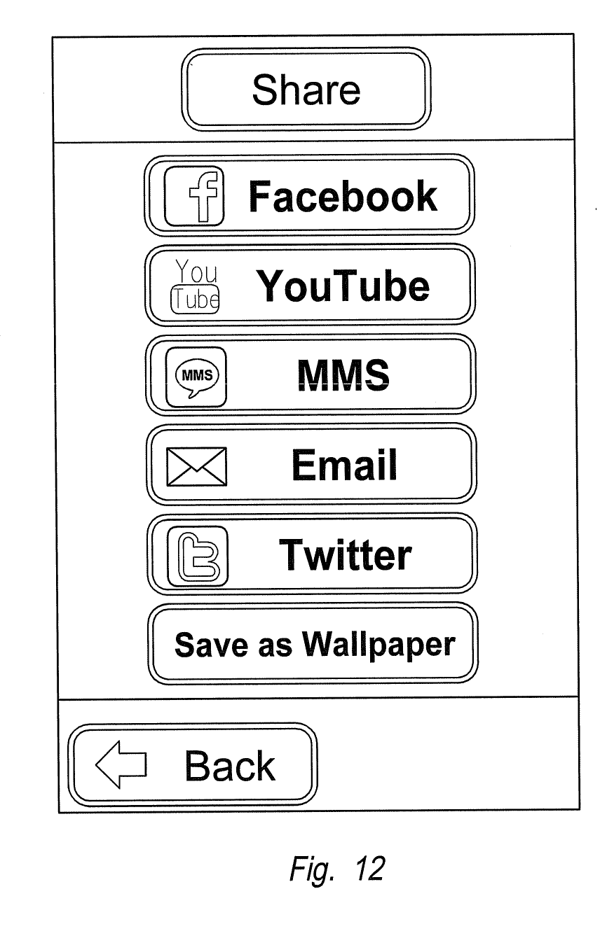

Still another choice the user has is to share the image, step 189 (FIGS. 7A and 12). Many choices can be provided for sharing. Examples include social networks and websites 191 such as Facebook and Twitter, text (MMS), email 193 and other networks such as video-sharing networks and websites 195 (You Tube). Pressing a choice opens a user interface for that choice, step 191. Many of these networks allow users to have accounts and require log ins, which log in or create log in screens are provided to the user, step 197. Once access to the desired location is obtained, the image can be sent or uploaded, step 201. Access to such networks requires the remote device to be connected to a cellular network, internet, etc. The user can also save the image as wallpaper for the remote device. Quit and cancel options are also provided. After sharing the image, the user is returned to the picture gallery, step 169.

As shown in FIG. 13, the picture gallery has by now changed in appearance in that the thumbnails previously marked “save” have a download icon 211 thereon and the user is provided with a download button 213. The saving of the images serves to select these images for download purposes, steps 215 and 217 (FIG. 7A). The user presses the download button 213, wherein the remote device sends a request to the camera, step 218. The camera downloads all of the image data for the selected images to the remote device. When downloaded, the images are marked with an indicator 219, such as a check mark.

The user can select one or more thumbnails on the screen by pressing on those thumbnails (for example once, to distinguish from pressing twice to view the enlarged image). The user can then press a “delete” button 221 (FIG. 10) to delete the selected images, step 223. The remote device transmits a signal to the camera to delete the selected images. Deleting images from the camera frees the memory for additional images.

The user can also select “refresh”, step 225 (see for example FIG. 9) wherein the remote device transmits a signal to the camera to refresh the images in the library.

The user can return to the main menu by selecting “refresh” or by selecting “back” (see FIGS. 7A, 7B and 8).

The user can add a camera, step 227 to the library of cameras. For example, if the user has recently installed a camera, the user will wish to add that camera to the library. The user selects “add” 223 (FIG. 8) from the menu, wherein the remote device looks for a camera, step 229 by transmitting a wake up signal as discussed above. If the new camera wakes up, it establishes communication with the remote device and sends its identifying information such as name, etc. The menu indicates that the new camera has been found, step 231 and the name is added to the library. Alternatively, if the new camera has not been found, the menu so indicates, step 233. In either instance, the user is returned to the main menu.

The camera unit and remote device can be adapted to a variety of platforms and operating systems. For example, the smart phone from Apple currently does not allow a software application to share image data directly. Instead, the image data is saved in a common library. The user, through the library, accesses the image data and then opens the application so as to view, edit, send, etc.

The camera unit can be used to stream image data such as video to the remote device. In streaming, a live or near real time feed is provided. For example, the image sensor captures an image, one frame at a time, which image is processed by the CPU. The image data is then transmitted over the wireless channel. The image data may be temporarily stored in memory or a buffer in the camera before transmission.

Alternatively, the camera unit can automatically send image data to the remote device upon acquiring the image data, or at some predetermined event. With this arrangement, the camera unit need not be queried by the remote device. The predetermined event can be a delay, for example 10 minutes, or can be a time of day, such as every day at 8:00 a.m.

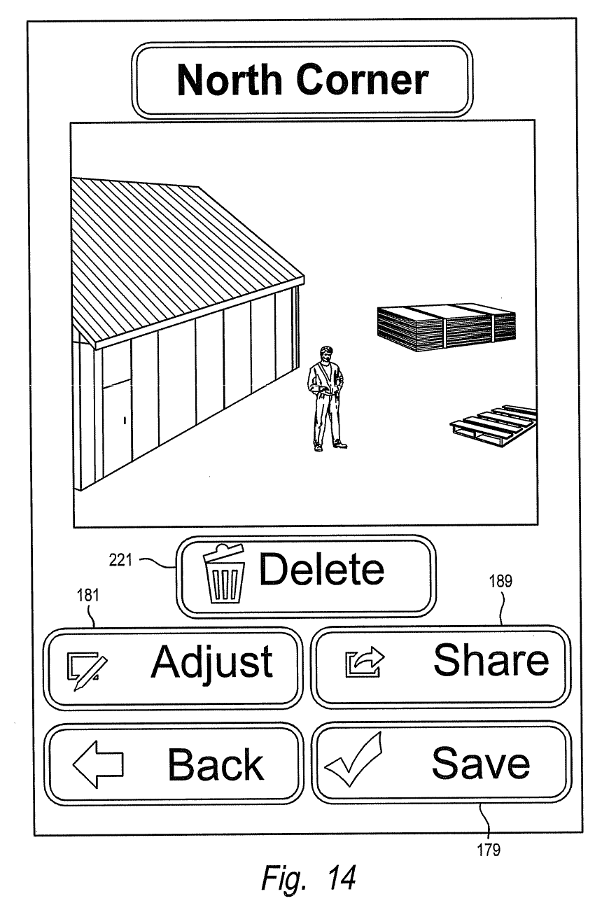

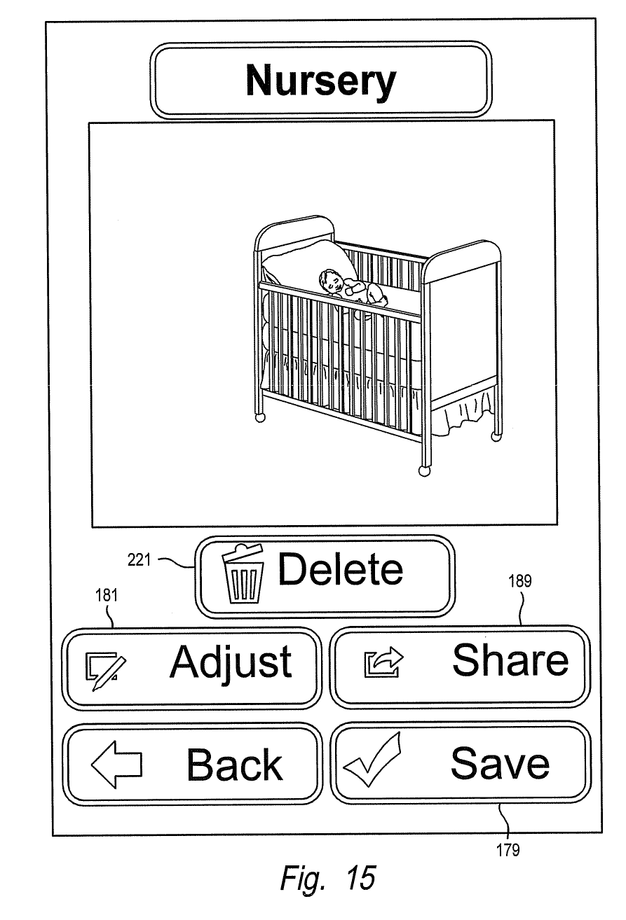

The camera unit can be used in other applications besides wildlife surveillance. For example, cameras can be located for security purposes, such as watching over a construction site. FIG. 14 shows an image form a camera on a construction site, showing a part of a building, a stack of materials and a person. Cameras could be used to monitor warehouses, offices, etc. FIG. 15 shows an image from a camera in a nursery with a crib and a baby. The cameras can be used to monitor personnel such as babies and baby sitters, au pairs, and so on.

The foregoing disclosure and showings made in the drawings are merely illustrative of the principles of this invention and are not to be interpreted in a limiting sense.

1. A surveillance camera system, comprising:
a) a camera comprising a lens, an image sensor aligned with the lens, a processor for processing images from the image sensor, an automatic trigger and a first wireless transceiver, the trigger triggering the camera to take at least one image upon sensing the object, the first wireless transceiver communicating over a channel;
b) a remote device comprising a second memory for storing mages and a second wireless transceiver, the second wireless transceiver communicating with the first wireless transceiver over the channel so that images from the camera first memory can be transferred over the channel to the remote device second memory.

2. The surveillance camera system of claim 1, wherein the triggering sensor comprises a motion sensor.

3. The surveillance camera system of claim 1, wherein the first and second wireless transceivers are first and second wifi transceivers.

4. The surveillance camera system of claim 1, wherein the remote device comprises a smart phone.

5. A method of operating a surveillance camera, comprising the steps of:
a) detecting a trigger event;
b) taking an image with the camera in response to the trigger event;
c) storing the images in the camera;
d) using a remote device, establishing a wireless communications channel with the camera;
e) communicating data and commands between the remote device and the camera over the communications channel.

6. The method of operating a surveillance camera of claim 5, wherein the step of detecting a trigger event further comprising the step of detecting an object moving in proximity to the camera.

7. The method of operating a surveillance camera of claim 5, wherein the step of detecting a trigger event further comprising the step of detecting a time interval.

8. The method of operating a surveillance camera of claim 5, wherein the step of communicating data and commands further comprises the step of transferring to the remote device preliminary information relating to the images taken by the camera.

9. The method of operating a surveillance camera of claim 8, wherein the step of transferring to the remote device preliminary information relating to the images further comprises the step of transmitting thumbnail images.

10. The method of operating a surveillance camera of claim 8, further comprising the steps of:
a) selecting from the remote device the images which are to be transferred from the camera to the remote device;
b) transferring the selection of images over the channel to the camera;
c) transferring the selected images from the camera to the remote device over the channel.

11. The method of operating a surveillance camera of claim 8, further comprising the step of editing from the remote device a selected image and creating edit information and transferring the edit information to the camera over the channel.

12. The method of operating a surveillance camera of claim 8, further comprising the steps of:
a) selecting from the remote device the images which are to be deleted from the camera;
b) transferring the selected images to the camera over the channel;
c) deleting the selected and stored images from the camera.

13. The method of operating a surveillance camera of claim 5, wherein the step of communicating data and commands between the remote device and the camera over the channel further comprises the step of transferring an identifier of the camera to the remote device.

14. The method of operating a surveillance camera of claim 5, further comprising the step of:
a) determining if a predetermined period of time has lapsed since the last communication of data or commands over the channel;
b) if the predetermined period of time has lapsed, terminating the communications channel.

15. A surveillance camera, comprising:
a) a lens;
b) an image sensor;
c) a memory;
d) a processor;
e) a wireless port;
f) a wireless unit that removably connects to the port, the wireless unit comprises a wireless transceiver.

16. The surveillance camera of claim 15, wherein:
a) the camera comprises a housing;
b) the wireless unit removably connects to the housing.

17. The surveillance camera of claim 16, wherein the wireless unit is located on a top of the camera housing.

18. A surveillance camera system, comprising:
a) a camera comprising a first memory for storing images, a first wireless transceiver, a wireless receiver and a processor, the processor operating the transceiver in a wake mode, wherein the transceiver can communicate over a first wireless channel, and a sleep mode wherein the transceiver cannot communicate over the first channel, the receiver operating on a second wireless channel;
b) a remote device having a second memory, a second wireless transceiver and a wireless transmitter, the second wireless transceiver capable of communicating with the first wireless transceiver over the first channel, the transmitter sending a wake up signal to the camera receiver over the second channel, wherein upon reception of the wake up signal by the camera the processor operates the first wireless transceiver in the wake mode so as to establish communication with the remote device over the first channel.

19. The surveillance camera system of claim 18, wherein the camera sends images in the first memory over the first channel to the remote device.

20. The surveillance camera system of claim 18, wherein the processor provides power to the first wireless transceiver to operate the first wireless transceiver in the wake mode.

21. The surveillance camera system of claim 20, wherein the processor changes the first wireless transceiver from the wake mode to the sleep mode if the first wireless transceiver does not communicate over the first channel for a predetermined period of time.

22. The surveillance camera system of claim 21, wherein the remote device comprises a first unit with the second memory and the second wireless transceiver, and a second unit with the transmitter, the first and second units being physically separable from each other.

23. The surveillance camera system of claim 22, wherein the first unit comprises a smart phone.

24. A method of operating a surveillance camera, comprising the steps of:
a) detecting a trigger event;
b) taking an image with the camera in response to the trigger event;
c) storing the images in the camera;
d) providing a wireless first transceiver with the camera, which first transceiver can communicate on a first channel;
e) operating the wireless first transceiver in a sleep mode wherein the first transceiver does not communicate over the first channel;
f) providing a remote device with a wireless second transceiver;
g) sending a wake up signal from the remote device to the camera over a second wireless channel;
h) receiving the wake up signal in the camera on the second channel;
i) after receiving the wake up signal, operating the first transceiver in a wake up mode and establishing communications between the first and second transceivers on the first channel.

25. The method of operating a surveillance camera of claim 24, wherein:
a) the step of sending a wake up signal further comprises the step of sending a coded wake up signal;
b) recognizing the wake up signal in the camera.

26. A method of operating a surveillance camera, comprising the steps of:
a) detecting a trigger event;
b) taking an image with the camera in response to the trigger event;
c) establishing a wireless communications channel between a remote device and the camera;
d) communicating the image over the communications channel with the remote device.
